(19) United States
(12) Patent Application Publication
(10) Pub. No.: US 2023/0251774 A1
(43) Pub. Date: Aug. 10, 2023

(54) METHOD OF DISPLAYING TEXT, ELECTRONIC DEVICE AND STORAGE MEDIUM

(71) Applicant: Beijing Baidu Netcom Science Technology Co., Ltd., Beijing (CN)

(72) Inventors: Shuangshuang Cui, Beijing (CN); Yongzheng Xin, Beijing (CN); Wensi Su, Beijing (CN); Huibin Zhao, Beijing (CN)

(21) Appl. No.: 18/300,221

(22) Filed: Apr. 13, 2023

(30) Foreign Application Priority Data
Apr. 15, 2022 (CN) 202210401363.0

(51) Int. Cl. G06F 3/0486; G06F 3/04842

(52) U.S. Cl. CPC G06F 3/0486; G06F 3/04842

(57) ABSTRACT

Provided are a method of displaying a text, an electronic device, and a storage medium, which relate to a field of artificial intelligence, and in particular to fields of content management and text technology. The method includes: determining, in a process of displaying a text page, a first target position associated with a target triggering operation in response to the target triggering operation being detected, wherein the target triggering operation indicates that a text content combination is to be performed; determining a target character content associated with the target triggering operation, in response to a text combination instruction, which is generated based on the target triggering operation, being detected; and adjusting a display position of the target character content to the first target position, so as to combine the target character content with a target text corresponding to the first target position to obtain a combined target text.

### CROSS-REFERENCE TO RELATED APPLICATIONS

This application is claims priority to Chinese Application No. 202210401363.0 filed on Apr. 15, 2022, which is incorporated herein by reference in its entirety.

### TECHNICAL FIELD

The present disclosure relates to a field of artificial intelligence, in particular to fields of content management and text technology, which may be applied to a scenario of displaying a text.

### BACKGROUND

With the development of the digital and online reading mode, electronic text reading is favored by more and more users. However, in some scenarios, the electronic text reading has the phenomenon of low efficiency and poor flexibility in text content management.

### SUMMARY

The present disclosure provides a method of displaying a text, an electronic device, and a storage medium.

According to an aspect of the present disclosure, a method of displaying a text is provided, including: determining, in a process of displaying a text page, a first target position associated with a target triggering operation in response to the target triggering operation being detected, wherein the target triggering operation indicates that a text content combination is to be performed; determining a target character content associated with the target triggering operation, in response to a text combination instruction, which is generated based on the target triggering operation, being detected; and adjusting a display position of the target character content to the first target position, so as to combine the target character content with a target text corresponding to the first target position to obtain a combined target text.

According to another aspect of the present disclosure, a method of displaying a text is provided, including: determining, in a process of displaying a text page, a target character content, to which a text combination cancellation is to be performed, in a combined target text and a character position range of the target character content in a source text, in response to a text combination cancellation instruction for the combined target text being detected; and adjusting a display position of the target character content according to the character position range, so as to cancel a combination of the target character content from the combined target text.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement any one of the above methods of displaying the text.

According to another aspect of the present disclosure, a non-transitory computer-readable storage medium having computer instructions stored thereon is provided, wherein the computer instructions are configured to cause a computer to implement any one of the above methods of displaying the text.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to understand the present disclosure better and do not constitute a limitation to the present disclosure, in which:

FIG. 1 schematically shows a system architecture of a method and an apparatus of displaying a text according to an embodiment of the present disclosure;

FIG. 2 schematically shows a flowchart of a method of displaying a text according to an embodiment of the present disclosure;

FIG. 3 schematically shows a flowchart of a method of displaying a text according to another embodiment of the present disclosure;

FIG. 4 schematically shows a flowchart of a method of displaying a text according to another embodiment of the present disclosure;

FIGS. 5A to 5E schematically show a process of displaying a text according to an embodiment of the present disclosure;

FIG. 6 schematically shows a block diagram of an apparatus of displaying a text according to an embodiment of the present disclosure;

FIG. 7 schematically shows a block diagram of an apparatus of displaying a text according to another embodiment of the present disclosure; and

FIG. 8 schematically shows a block diagram of an electronic device for performing a method of displaying a text according to an embodiment of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

The terms used here are only for describing specific embodiments, and are not intended to limit the present disclosure. The terms “include”, “comprise”, etc. used herein indicate an existence of described characteristics, steps, operations and/or components, but do not exclude a presence or addition of one or more other characteristics, steps, operations or components.

Unless otherwise defined, all terms (including technical and scientific terms) used herein have the meanings commonly understood by those skilled in the art. It should be noted that the terms used here should be interpreted as having meanings consistent with the context of the specification, and should not be interpreted in an idealized or overly rigid manner.

In the case of using an expression similar to “at least one of A, B, C, etc.”, generally speaking, it should be interpreted according to the meaning of the expression commonly understood by those skilled in the art (for example, “a system having at least one of A, B, and C” shall include, but is not limited to, a system having A alone, B alone, C alone, A and B, A and C, B and C, and/or A, B and C, etc.).

The embodiments of the present disclosure provide a method of displaying a text. This method includes: determining, in a process of displaying a text page, a first target position associated with a target triggering operation in response to the target triggering operation being detected, and the target triggering operation indicates that a text content combination is to be performed; determining a target character content associated with the target triggering operation, in response to a text combination instruction, which is generated based on the target triggering operation, being detected; and adjusting a display position of the target character content to the first target position, so as to combine the target character content with a target text corresponding to the first target position to obtain a combined target text.

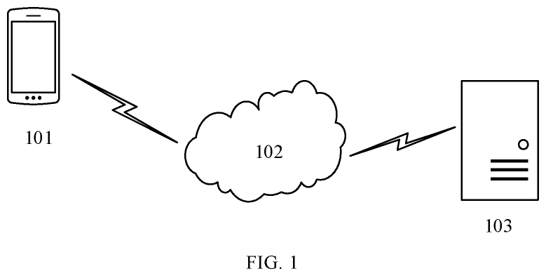

FIG. 1 schematically shows a system architecture of a method and an apparatus of displaying a text according to an embodiment of the present disclosure. It should be noted that FIG. 1 is only an example of system architectures in which the embodiments of the present disclosure may be applied to help those skilled in the art understand the technical content of the present disclosure, but it does not mean that the embodiments of the present disclosure may not be used in other devices, systems, environments or scenarios.

A system architecture 100 according to the embodiment may include a display terminal 101, a network 102 and a server 103. The network 102 is used to provide a medium for communication links between the display terminal 101 and the server 103. The network 102 may include various connection types, such as a wired communication link, a wireless communication link, or a fiber cable etc. The server 103 may be an independent physical server, a server cluster or a distributed system composed of a plurality of physical servers, and may be a cloud server that provides basic cloud computing services such as a cloud service, cloud computing, a network service, and a middleware service, etc.

The display terminal 101 interacts with the server 103 through the network 102, so as to receive or transmit data, etc. For example, the display terminal 101 may be a user terminal with a display function, such as a mobile phone, a notebook computer, a tablet computer, a reader, etc., and the display terminal 101 may be used to display a text page.

The server 103 may be a server that provides various services, such as a background processing server (only an example) that combines text content according to a detected target triggering operation.

For example, in a process of displaying a text page through the display terminal 101, the server 103 determines a first target position associated with a target triggering operation in response to the target triggering operation being detected, and the target triggering operation indicates that a text content combination is to be performed; determines a target character content associated with the target triggering operation, in response to a text combination instruction, which is generated based on the target triggering operation, being detected; and adjusts a display position of the target character content to the first target position, so as to combine the target character content with a target text corresponding to the first target position to obtain a combined target text.

It should be noted that the method of displaying a text provided by the embodiments of the present disclosure may be executed by the server 103. Correspondingly, the apparatus of displaying a text provided by the embodiments of the present disclosure may be disposed in the server 103. The method of displaying a text provided by the embodiments of the present disclosure may also be executed by a server or a server cluster different from the server 103 and capable of communicating with the display terminal 101 and/or the server 103. Correspondingly, the apparatus of displaying a text provided by the embodiments of the present disclosure may also be disposed in the server or the server cluster different from the server 103 and capable of communicating with the display terminal 101 and/or the server 103.

It should be understood that the numbers of display terminals, networks and servers in FIG. 1 are merely illustrative. According to implementation needs, there may be any number of display terminals, networks and servers.

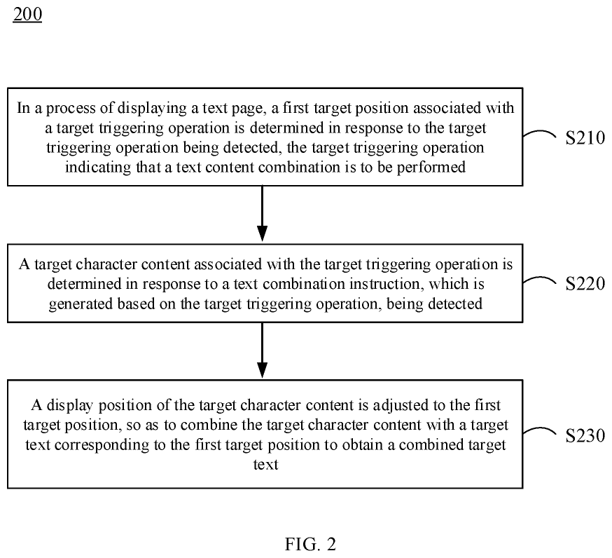

The embodiments of the present disclosure provide a method of displaying a text. The method of displaying a text according to the exemplary embodiment of the present disclosure is described with reference to FIGS. 2 to 4 in combination with the system architecture of FIG. 1. The method of displaying a text according to the embodiment of the present disclosure may be executed by the server 103 shown in FIG. 1, for example.

FIG. 2 schematically shows a flowchart of a method of displaying a text according to an embodiment of the present disclosure.

As shown in FIG. 2, a method 200 of displaying a text according to an embodiment of the present disclosure may include operations S210 to S230.

In operation S210, in a process of displaying a text page, a first target position associated with a target triggering operation is determined in response to the target triggering operation being detected, the target triggering operation indicating that a text content combination is to be performed.

In operation S220, a target character content associated with the target triggering operation is determined in response to a text combination instruction, which is generated based on the target triggering operation, being detected.

In operation S230, a display position of the target character content is adjusted to the first target position, so as to combine the target character content with a target text corresponding to the first target position to obtain a combined target text.

The following example illustrates an example process of each operation of the method of displaying a text according to this embodiment.

For example, in a process of displaying a text page, a first target position associated with a target triggering operation is determined in response to the target triggering operation being detected. The target triggering operation includes at least one preset triggering operation for indicating that the text content combination is to be performed. The target triggering operation, for example, may include a text selecting operation and a text dragging operation generated based on the text selecting operation.

The first target position associated with the target triggering operation may indicate, for example, a target text, to which a text content combination is to be performed, and a target character position in the target text. A target character content associated with the target triggering operation is determined in response to a text combination instruction, which is generated based on the target triggering operation, being detected. The target character content may include, for example, a character content, to which a text content combination is to be performed, in the source text. The target character content may include content of some of the characters in the source text, or content of all the characters in the source text.

A display position of the target character content is adjusted from an initial position in the source text to the first target position, so as to delete the target character content in the source text and combine the target character content with a target text corresponding to the first target position.

For example, in response to the target triggering operation being detected, a target character position, at which the text content combination is to be performed, in the target text indicated by the target triggering operation is determined as the first target position. In response to the text combination instruction, which is generated based on the target triggering operation, being detected, the target character content, to which the text content combination is to be performed, in the source text indicated by the target triggering operation is determined. A display position of the target character content is adjusted from an initial position in the source text to the target character position, so as to combine the target character content with the target text, and the target character position constitutes the text combination position.

In an example, in a process of displaying a text page, in response to the text selecting operation and the text dragging operation generated based on the text selecting operation being detected, the text selecting operation and the text dragging operation are determined as the target triggering operations.

The first target position indicated by the text dragging operation is determined in response to the text dragging operation being detected. In response to the text combination instruction, which is generated based on the text dragging operation, being detected, a character content selected by the text selecting operation is determined as the target character content. The display position of the target character content is adjusted to the first target position, so as to combine the target character content with the target text corresponding to the first target position.

Through the embodiments of the present disclosure, a first target position associated with a target triggering operation is determined in response to the target triggering operation being detected, a target character content associated with the target triggering operation is determined in response to a text combination instruction, which is generated based on the target triggering operation, being detected, and a display position of the target character content is adjusted to the first target position, so as to combine the target character content with a target text corresponding to the first target position. This is conductive to achieving an efficient and convenient text content combination based on the preset triggering operation, effectively improving the flexibility and operability of the text content management, effectively solving the problem of text content fragmentation, reducing the time cost of the text content management, and effectively satisfying the diversified text content management requirement of the user.

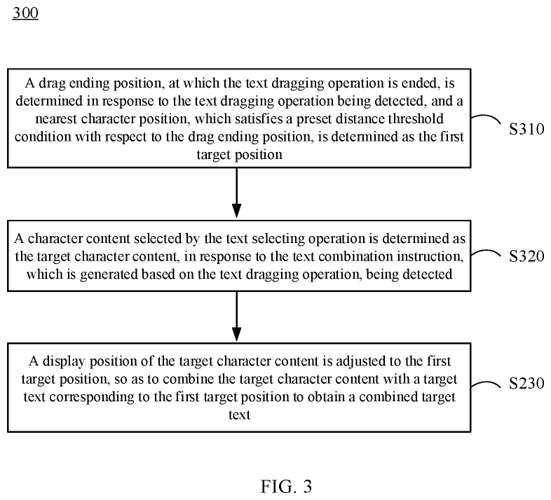

FIG. 3 schematically shows a flowchart of a method of displaying a text according to another embodiment of the present disclosure.

As shown in FIG. 3, a method 300 of displaying a text according to an embodiment of the present disclosure may include operations S310, S320, and S230.

In operation S310, a drag ending position, at which the text dragging operation is ended, is determined in response to the text dragging operation being detected, and a nearest character position, which satisfies a preset distance threshold condition with respect to the drag ending position, is determined as the first target position.

In operation S320, a character content selected by the text selecting operation is determined as the target character content, in response to the text combination instruction, which is generated based on the text dragging operation, being detected.

In operation S230, a display position of the target character content is adjusted to the first target position, so as to combine the target character content with a target text corresponding to the first target position to obtain a combined target text.

The following example illustrates an example process of each operation of the method of displaying a text according to this embodiment.

For example, in a process of displaying a text page, in response to the text selecting operation and the text dragging operation generated based on the text selecting operation being detected, the text selecting operation and the text dragging operation are determined as the target triggering operations. The text selecting operation may include, for example, a mouse selecting operation, a touch selecting operation, etc., and the text dragging operation may include, for example, a mouse dragging operation, a touch sliding operation, etc. generated based on the text selecting operation, which are not limited in this embodiment.

A drag ending position at which the text dragging operation is ended is determined in response to the text dragging operation being detected. A nearest character position, which satisfies a preset distance threshold condition with respect to the drag ending position, is determined as the first target position. In response to a fact that there is a candidate character position satisfying the preset distance threshold condition with respect to the drag ending position, the candidate character position nearest to the drag ending position is determined as the first target position. In response to a fact that there is no candidate character position satisfying the preset distance threshold condition with respect to the drag ending position, the text dragging operation is determined to be invalid.

In an example, the first target position may be highlighted so that the user may confirm whether the first target position is consistent with the target character position, at which the text content combination is to be performed. For example, the first target position may be displayed in form of a cursor, so that the user may confirm whether a position of the cursor is consistent with the target character position, at which the text content combination is to be performed. In a case that the first target position and the target character position, at which the text content combination is to be performed, are confirmed to be inconsistent, the user may continue the text dragging operation until the first target position indicated by the text dragging operation is consistent with the target character position.

In a process of displaying a text page, the text combination instruction generated based on the text dragging operation is detected. For example, an ending event in which the text dragging operation is ended is determined as the text combination instruction in response to the ending event being detected. Alternatively, at least one content operation option is displayed in response to the ending event being detected, and a selection event, in which a text combination option is selected from the at least one content operation option, is determined as the text combination instruction in response to the selection event.

Detecting the text combination instruction generated based on text dragging operation and performing the text content combination according to the detected text combination instruction are conducive to achieving efficient and convenient text content combination and may effectively solve the problem of text content fragmentation.

For example, in a case that the text dragging operation is the touch sliding operation, an ending event in which the text dragging operation is ended may be a touch ending event, and the touch ending event may be determined as the text combination instruction. Alternatively, at least one content operation option is displayed in response to the touch ending event being detected, and a selection event, in which a text combination option is selected from the at least one content operation option, is determined as the text combination instruction in response to the selection event.

A character content selected by the text selecting operation is determined as the target character content in response to the text combination instruction, which is generated based on the text dragging operation, being detected. A display position of the target character content is adjusted to the first target position, so as to combine the target character content with a target text corresponding to the first target position.

After combining the target character content with the target text corresponding to the first target position, the target character content is displayed in a first display mode, and the target text is displayed in a second display mode different from the first display mode. Highlighting the target character content is conductive to visually distinguishing original character content from other character content added by combination in the combined target text, and achieving efficient and convenient text content management.

For example, a character position range of the target character content in a source text may be determined. The character position range may be defined by, for example, a starting character position and an ending character position of the target character content. As another example, the character position range may be defined by the starting character position and a character length of the target character content. As another example, the character position range may be defined by the ending character position and the character length of the target character content. As another example, the character position range may be defined by any character position and a character association relationship of the target character content, which is not limited in this embodiment.

A character content behind the character position range in the source text may be determined as a first candidate content. A starting display position of the first candidate content is adjusted to a starting character position of the character position range. After adjusting the display position of the target character content to the first target position, deleting the target character content from the source text may be achieved. The starting display position of the first candidate content is adjusted to the starting character position of the character position range. Continuously displaying the character content in the combined source text may be achieved by replacing the target character content with the first candidate content.

The target character content may include content of some of the characters in the source text, or content of all the characters in the source text. In a case that the target character content includes content of all the characters in the source text, a text combination based on the first target position may be performed between the content of all the characters and the target text, so as to obtain the combined target text.

In an example, a character content behind the first target position in the target text may be determined as a second candidate content. A starting display position of the second candidate content is adjusted to a second target position, and the second target position is determined according to the first target position and a character length of the target character content.

For example, the first target position may be the starting character position of the target character content. The second target position may be determined according to the first target position and the character length of the target character content. The second target position may be the ending character position of the target character content. A starting display position of the second candidate content may be adjusted to a next character position located behind the ending character position of the target character content. Continuously displaying the character content in the combined target text may be achieved by moving the display position of the second candidate content backward as a whole based on the length of the target character content.

Adjusting the starting display position of the first candidate content is conductive to continuously displaying the character content in the combined source text. Adjusting the starting display position of the second candidate content is conductive to continuously displaying the character content in the combined target text. This may effectively improve the usability of text content combination, effectively solve the problem of text content fragmentation, and is conducive to satisfying the diversified text combination requirement of the user.

Through the embodiments of the present disclosure, the first target position indicated by the text dragging operation is determined in response to the text dragging operation being detected. In response to the text combination instruction, which is generated based on the text dragging operation, being detected, the character content selected by the text selecting operation is determined as the target character content. The display position of the target character content is adjusted to the first target position, so as to combine the target character content with the target text corresponding to the first target position. This is conducive to achieving efficient and convenient text content combination, effectively solving the problem of text content fragmentation, and reducing the time and cost consumption of text content management. Performing the text content combination based on the detected text selecting operation and text dragging operation may effectively improve the flexibility of text content combination, and is conducive to satisfying the diversified text content management requirement of the user.

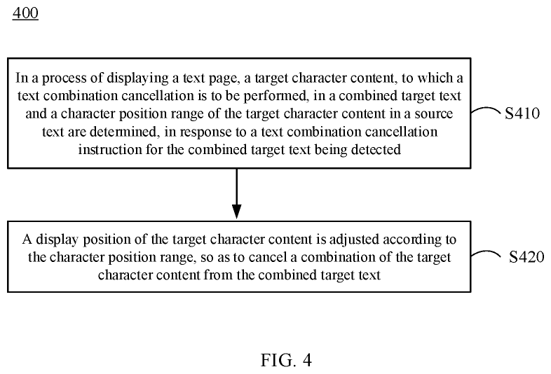

FIG. 4 schematically shows a flowchart of a method of displaying a text according to another embodiment of the present disclosure.

As shown in FIG. 4, a method 400 of displaying a text according to an embodiment of the present disclosure may include operations S410 and S420.

In operation S410, in a process of displaying a text page, a target character content to which a text combination cancellation is to be performed in a combined target text and a character position range of the target character content in a source text are determined, in response to a text combination cancellation instruction for the combined target text being detected.

In operation S420, a display position of the target character content is adjusted according to the character position range, so as to cancel a combination of the target character content from the combined target text.

The following example illustrates an example process of each operation of the method of displaying a text according to this embodiment.

For example, in a process of displaying a text page, a target character content to which a text combination cancellation is to be performed in a combined target text and a character position range of the target character content in a source text are determined, in response to a text combination cancellation instruction for the combined target text being detected. The character position range may include at least one character position of the target character content in the source text, for example.

For example, in a process of displaying a text page, at least one content operation option is displayed in response to the target triggering operation for the combined target text being detected. The target triggering operation may be a touch moving operation that satisfies a preset condition, such as a touch moving operation that satisfies a preset direction condition. In response to a selection event, in which a text combination cancellation option is selected from the at least one content operation option, the selection event is determined as the text combination cancellation instruction.

The target character content, to which a text combination cancellation is to be performed, in the combined target text is determined. For example, the character content whose initial display position is different from the target text may be determined as the target character content to which the text combination cancellation is to be performed. Alternatively, the character content that is displayed differently from the target text may be determined as the target character content to which the text combination cancellation is to be performed.

The character position range of the target character content in the source text is determined. The display position of the target character content is adjusted according to the character position range, so as to cancel the combination of the target character content and the combined target text. For example, the starting display position of the target character content may be adjusted to the starting character position according to the starting character position based on the source text indicated by the character position range. According to the ending character position indicated by the character position range based on the source text, the ending display position of the target character content may be adjusted to the ending character position. Alternatively, according to any character position indicated by the character position range based on the source text, the character display position of the target character content may be adjusted to the corresponding character position.

By adjusting the display position of the target character content, it is possible to achieve deleting the target character content from the target text and restoring the target character content into the source text, so as to cancel the combination of the target character content and the combined target text.

For example, according to a starting character position of the character position range, a character content behind the starting character position in the source text may be determined as a third candidate content. A starting display position of the third candidate content is adjusted according to the starting character position and a character length of the target character content.

The ending character position of the target character content may be determined according to the starting character position and the character length of the target character content. The starting display position of the third candidate content may be adjusted based on the ending character position. For example, the starting display position of the third candidate content is adjusted to a next character position located behind the ending character position of the target character content. Continuously displaying the character content in the source text after combination cancellation may be achieved by moving the display position of the third candidate content backward as a whole based on the length of the target character content.

As another example, according to a current position range of the target character content in the combined target text, a character content behind the current position range is determined as a fourth candidate content. A starting display position of the fourth candidate content is adjusted to a starting character position of the current position range. By replacing the target character content with the fourth candidate content, it is possible to achieve continuously displaying of the character content in the target text for which the combination is canceled.

Adjusting the starting display position of the third candidate content is conductive to continuously displaying the character content in the source text for which the combination canceled. Adjusting the starting display position of the fourth candidate content is conductive to continuously displaying the character content in the target text for which the combination is canceled. This may effectively improve the intelligence of text content management and effectively improve the operation convenience of text content management.

Through the embodiments of the present disclosure, a target character content, to which a text combination cancellation is to be performed, in a combined target text and a character position range of the target character content in a source text are determined, in response to a text combination cancellation instruction for the combined target text being detected, and a display position of the target character content is adjusted according to the character position range, so as to cancel a combination of the target character content from the combined target text. This may effectively improve the operation convenience of text combination cancellation, facilitate achieving the efficient and flexible text content management, effectively reduce the time cost consumption and operation complexity of electronic text management, effectively improve the intelligent degree of electronic text management, and is conductive to satisfying the diversified electronic text management requirement of the user.

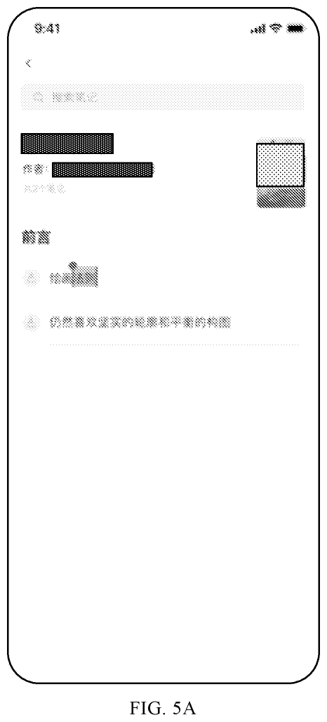

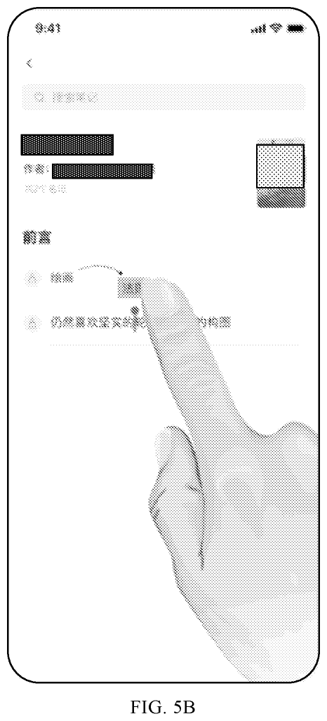

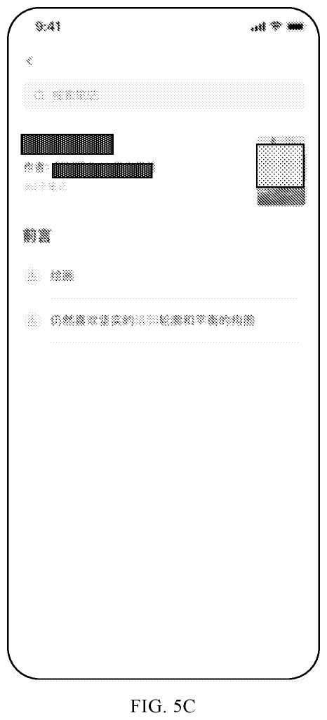

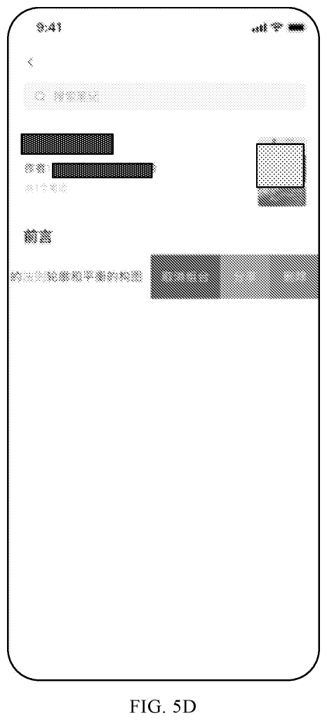

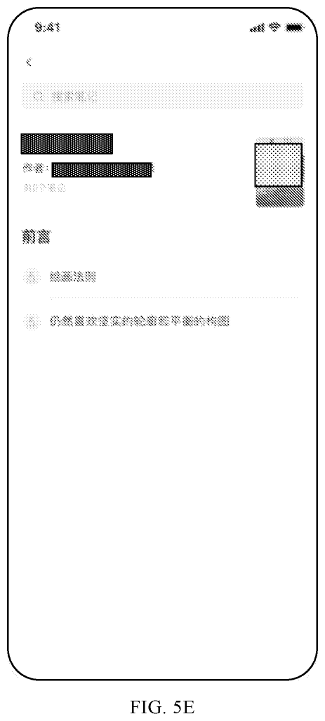

FIGS. 5A to 5E schematically shows a process of displaying a text according to an embodiment of the present disclosure.

The process of displaying a text may include, for example, a plurality of sub-processes of displaying a text as shown in FIGS. 5A to 5E.

As shown in FIG. 5A, in a process of displaying a text page, a text selecting operation for the target character content is detected. The target character content may include content of some of the characters in the source text, or content of all the characters in the source text.

A text being a note is taken as an example for illustration. The target character content may include content of some Chinese characters [symbol] in a source note. It is also possible for the target character content to include content of all the Chinese characters [symbol] [symbol] in the source note.

As shown in FIG. 5B, in the process of displaying a text page, a text dragging operation generated based on the text selecting operation is detected. A first target position indicated by the text dragging operation is determined. The first target position may be, for example, a nearest character position which satisfies a preset distance threshold condition with respect to the drag ending position.

The first target position may indicate a target text, to which the text content combination is to be performed, and a target character position in the target text. A text being a note is taken as an example for illustration. A target note, to which the text content combination is to be performed, may include content of Chinese characters

[symbol]

[symbol]

As shown in FIG. 5C, a display position of the target character content may be adjusted to a first target position, so as to delete the target character content from the source text, and combine the target character content with the target text corresponding to the first target position to obtain a combined target text.

For example, the target character content may be displayed in a first display mode, and the target text may be displayed in a second display mode different from the first display mode.

A text being a note is taken as an example for illustration. The display position of the target character content may be adjusted to the first target position, so as to delete the target character content in the source note, and combine the target character content with the target note corresponding to the first target position to obtain a combined target note.

As shown in FIG. 5D, in a process of displaying a text page, a text combination cancellation instruction for the combined target text is detected. A target character content, to which a text combination cancellation is to be performed, in a combined target text and a character position range of the target character content in a source text are determined, in response to the detected text combination cancellation instruction.

A text being a note is taken as an example for illustration. A target character content, to which a note combination cancellation is to be performed, may include content of Chinese characters

[symbol]

As shown in FIG. 5E, a display position of the target character content is displayed according to the character position range, so as to cancel a combination of the target character content from the target text and restore the target character content in the source text.

A text being a note is taken as an example for illustration. A display position of the target character content is displayed according to the character position range, so as to cancel a combination of the target character content from the target note and restore the target character content in the source note.

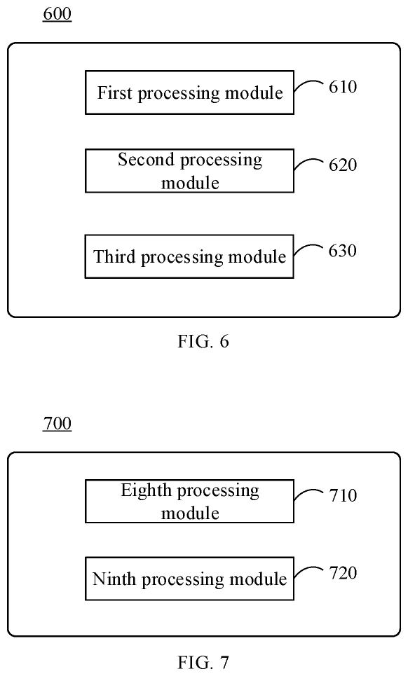

FIG. 6 schematically shows a block diagram of an apparatus of displaying a text according to an embodiment of the present disclosure.

As shown in FIG. 6, an apparatus 600 of displaying a text, for example, includes a first processing module 610, a second processing module 620 and a third processing module 630.

The first processing module 610 is used to determine, in a process of displaying a text page, a first target position associated with a target triggering operation in response to the target triggering operation being detected, and the target triggering operation indicates that a text content combination is to be performed. The second processing module 620 is used to determine a target character content associated with the target triggering operation, in response to a text combination instruction, which is generated based on the target triggering operation, being detected. The third processing module 630 is used to adjust a display position of the target character content to the first target position, so as to combine the target character content with a target text corresponding to the first target position to obtain a combined target text.

Through the embodiments of the present disclosure, a first target position associated with a target triggering operation is determined in response to the target triggering operation being detected, a target character content associated with the target triggering operation is determined in response to a text combination instruction, which is generated based on the target triggering operation, being detected, and a display position of the target character content is adjusted to the first target position, so as to combine the target character content with a target text corresponding to the first target position, which is conductive to achieving an efficient and convenient text content combination based on the preset triggering operation, effectively improving the flexibility and operability of the text content management, effectively solving the problem of text content fragmentation, reducing the time cost consumption of the text content management, and effectively satisfying the diversified text content management requirement of the user.

According to an embodiment of the present disclosure, the target triggering operation includes a text selecting operation and a text dragging operation generated based on the text selecting operation.

According to an embodiment of the present disclosure, the first processing module includes: a first processing sub-module used to determine a drag ending position at which the text dragging operation is ended, in response to the text dragging operation being detected; and a second processing sub-module used to determine a nearest character position which satisfies a preset distance threshold condition with respect to the drag ending position, as the first target position.

According to an embodiment of the present disclosure, the apparatus further includes a fourth processing module used to determine an ending event in which the text dragging operation is ended as the text combination instruction in response to the ending event being detected; or display at least one content operation option in response to the ending event being detected, and determine a selection event, in which a text combination option is selected from the at least one content operation option, as the text combination instruction in response to the selection event.

According to an embodiment of the present disclosure, the second processing module includes a third processing sub-module used to determine a character content selected by the text selecting operation as the target character content, in response to the text combination instruction, which is generated based on the text dragging operation, being detected.

According to an embodiment of the present disclosure, the apparatus further includes a fifth processing module used to determine a character position range of the target character content in a source text; determine, in the source text, a character content behind the character position range as a first candidate content; and adjust a starting display position of the first candidate content to a starting character position of the character position range.

According to an embodiment of the present disclosure, the apparatus further includes a sixth processing module used to determine, in the target text, a character content behind the first target position as a second candidate content; and adjust a starting display position of the second candidate content to a second target position, and the second target position is determined according to the first target position and a character length of the target character content.

According to an embodiment of the present disclosure, the apparatus further includes a seventh processing module used to display the target character content in a first display mode and display the target text in a second display mode, and the first display mode is different from the second display mode.

FIG. 7 schematically shows a block diagram of an apparatus of displaying a text according to another embodiment of the present disclosure.

As shown in FIG. 7, an apparatus 700 of displaying a text, for example, includes an eighth processing module 710 and a ninth processing module 720.

The eighth processing module 710 is used to determine, in a process of displaying a text page, a target character content, to which a text combination cancellation is to be performed, in a combined target text and a character position range of the target character content in a source text, in response to a text combination cancellation instruction for the combined target text being detected. The ninth processing module 720 is used to adjust a display position of the target character content according to the character position range, so as to cancel a combination of the target character content from the combined target text.

Through the embodiments of the present disclosure, a target character content, to which a text combination cancellation is to be performed, in a combined target text and a character position range of the target character content in a source text are determined, in response to a text combination cancellation instruction for the combined target text being detected, and a display position of the target character content is adjusted according to the character position range, so as to cancel a combination of the target character content from the combined target text, which may effectively improve the operation convenience of text combination cancellation, facilitate achieving the efficient and flexible text content management, effectively reduce the time cost consumption and operation complexity of electronic text management, effectively improve the intelligent degree of electronic text management, and is conductive to satisfying the diversified electronic text management requirement of the user.

According to an embodiment of the present disclosure, the apparatus further includes a tenth processing module used to determine, according to a starting character position of the character position range, a character content behind the starting character position in the source text as a third candidate content; and adjust a starting display position of the third candidate content according to the starting character position and a character length of the target character content.

According to an embodiment of the present disclosure, the apparatus further includes an eleventh processing module used to determine, according to a current position range of the target character content in the combined target text, a character content behind the current position range as a fourth candidate content; and adjust a starting display position of the fourth candidate content to a starting character position of the current position range.

It should be noted that in the technical solution of the present disclosure, the collection, storage, use, processing, transmission, provision, disclosure and application of the user's personal information involved are all in compliance with the relevant laws and regulations, and do not violate the public order and good customs.

According to an embodiment of the present disclosure, the present disclosure further provides an electronic device, a readable storage medium and a computer program product.

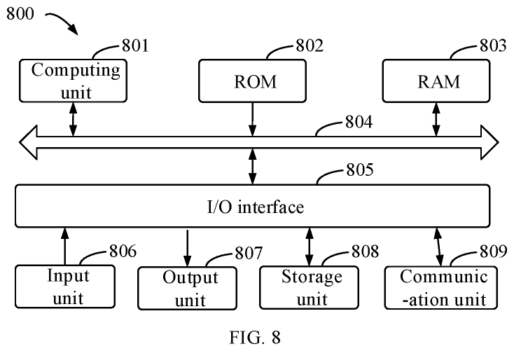

FIG. 8 schematically shows a block diagram of an electronic device for performing a method of displaying a text according to an embodiment of the present disclosure.

FIG. 8 shows a schematic block diagram of an exemplary electronic device 800 for implementing the embodiments of the present disclosure. The electronic device 800 is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the device 800 may include a computing unit 801, which may perform various appropriate actions and processing based on a computer program stored in a read-only memory (ROM) 802 or a computer program loaded from a storage unit 808 into a random access memory (RAM) 803. Various programs and data required for the operation of the device 800 may be stored in the RAM 803. The computing unit 801, the ROM 802 and the RAM 803 are connected to each other through a bus 804. An input/output (I/O) interface 805 is further connected to the bus 804.

Various components in the device 800, including an input unit 806 such as a keyboard, a mouse, etc., an output unit 807 such as various types of displays, speakers, etc., a storage unit 808 such as a magnetic disk, an optical disk, etc., and a communication unit 809 such as a network card, a modem, a wireless communication transceiver, etc., are connected to the I/O interface 805. The communication unit 809 allows the device 800 to exchange information/data with other devices through a computer network such as the Internet and/or various telecommunication networks.

The computing unit 801 may be various general-purpose and/or special-purpose processing components with processing and computing capabilities. Some examples of the computing unit 801 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 801 may perform the various methods and processes described above, such as the method of displaying the text. For example, in some embodiments, the method of displaying the text may be implemented as a computer software program that is tangibly contained on a machine-readable medium, such as the storage unit 808. In some embodiments, part or all of a computer program may be loaded and/or installed on the device 800 via the ROM 802 and/or the communication unit 809. When the computer program is loaded into the RAM 803 and executed by the computing unit 801, one or more steps of the method of displaying the text described above may be performed. Alternatively, in other embodiments, the computing unit 801 may be used to perform the method of displaying the text in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a special-purpose or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, and infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of displaying a text, comprising:
determining, in a process of displaying a text page, a first target position associated with a target triggering operation in response to the target triggering operation being detected, wherein the target triggering operation indicates that a text content combination is to be performed;
determining a target character content associated with the target triggering operation, in response to a text combination instruction, which is generated based on the target triggering operation, being detected; and
adjusting a display position of the target character content to the first target position, so as to combine the target character content with a target text corresponding to the first target position to obtain a combined target text.

2. The method according to claim 1, wherein the target triggering operation comprises a text selecting operation and a text dragging operation generated based on the text selecting operation.

3. The method according to claim 2, wherein determining the first target position associated with the target triggering operation in response to the target triggering operation being detected comprises:
determining a drag ending position at which the text dragging operation is ended, in response to the text dragging operation being detected; and
determining a nearest character position which satisfies a preset distance threshold condition with respect to the drag ending position, as the first target position.

4. The method according to claim 2, further comprising:
determining an ending event in which the text dragging operation is ended as the text combination instruction in response to the ending event being detected; or
displaying at least one content operation option in response to the ending event being detected, and determining a selection event, in which a text combination option is selected from the at least one content operation option, as the text combination instruction in response to the selection event.

5. The method according to claim 2, wherein determining the target character content associated with the target triggering operation, in response to the text combination instruction, which is generated based on the target triggering operation, being detected comprises:
determining as the target character content a character content selected by the text selecting operation, in response to the text combination instruction, which is generated based on the text dragging operation, being detected.

6. The method according to claim 1, further comprising:
determining a character position range of the target character content in a source text;
determining, in the source text, a character content behind the character position range as a first candidate content; and
adjusting a starting display position of the first candidate content to a starting character position of the character position range.

7. The method according to claim 1, further comprising:
determining, in the target text, a character content behind the first target position as a second candidate content; and
adjusting a starting display position of the second candidate content to a second target position, wherein the second target position is determined according to the first target position and a character length of the target character content.

8. The method according to claim 1, further comprising:
displaying the target character content in a first display mode, and displaying the target text in a second display mode, wherein the first display mode is different from the second display mode.

9. A method of displaying a text, comprising:
determining, in a process of displaying a text page, a target character content, to which a text combination cancellation is to be performed, in a combined target text and a character position range of the target character content in a source text, in response to a text combination cancellation instruction for the combined target text being detected; and
adjusting a display position of the target character content according to the character position range, so as to cancel a combination of the target character content from the combined target text,
wherein the combined target text is obtained by the method according to claim 1.

10. The method according to claim 9, further comprising:
determining, according to a starting character position of the character position range, a character content behind the starting character position in the source text as a third candidate content; and
adjusting a starting display position of the third candidate content according to the starting character position and a character length of the target character content.

11. The method according to claim 9, further comprising:
determining, according to a current position range of the target character content in the combined target text, a character content behind the current position range as a fourth candidate content; and
adjusting a starting display position of the fourth candidate content to a starting character position of the current position range.

12. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

13. The electronic device according to claim 12, wherein the target triggering operation comprises a text selecting operation and a text dragging operation generated based on the text selecting operation.

14. The electronic device according to claim 13, wherein the at least one processor is further configured for:
determining a drag ending position at which the text dragging operation is ended, in response to the text dragging operation being detected; and
determining a nearest character position which satisfies a preset distance threshold condition with respect to the drag ending position, as the first target position.

15. The electronic device according to claim 13, wherein the at least one processor is further configured for:
determining an ending event in which the text dragging operation is ended as the text combination instruction in response to the ending event being detected; or
displaying at least one content operation option in response to the ending event being detected, and determining a selection event, in which a text combination option is selected from the at least one content operation option, as the text combination instruction in response to the selection event.

16. The electronic device according to claim 13, wherein the at least one processor is further configured for:
determining as the target character content a character content selected by the text selecting operation, in response to the text combination instruction, which is generated based on the text dragging operation, being detected.

17. The electronic device according to claim 13, wherein the at least one processor is further configured for:
determining a character position range of the target character content in a source text;
determining, in the source text, a character content behind the character position range as a first candidate content; and
adjusting a starting display position of the first candidate content to a starting character position of the character position range.

18. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 9.

19. A non-transitory computer-readable storage medium having computer instructions stored thereon, wherein the computer instructions are configured to cause a computer to implement the method of claim 1.

20. A non-transitory computer-readable storage medium having computer instructions stored thereon, wherein the computer instructions are configured to cause a computer to implement the method of claim 9.
